(19) United States
(12) Patent Application Publication
(10) Pub. No.: US 2017/0282508 A1
(43) Pub. Date: Oct. 5, 2017

(54) CARBON FIBER PREPREG

(71) Applicant: TYKO TECH. CO., LTD, New Taipei City (TW)

(72) Inventors: CHIH-HSIAO CHIEN, New Taipei City (TW); CHING-CHUN LIN, New Taipei City (TW)

(73) Assignee: TYKO TECH. CO., LTD, New Taipei City (TW)

(21) Appl. No.: 15/220,344

(22) Filed: Jul. 26, 2016

(30) Foreign Application Priority Data
Apr. 1, 2016 (TW) 105204660

(51) Int. Cl. B32B 27/12

(52) U.S. Cl. CPC B32B 27/12; B32B 2262/106; B32B 2260/023; B32B 2260/046; B32B 2305/076

(57) ABSTRACT

A carbon fiber prepreg is disclosed. The carbon fiber prepreg, exclusive of any additive scrims, comprises a multiple carbon fiber layers and resin layers in an integral form, characterized in that: for the carbon fiber prepreg at each standard unit of the carbon fiber prepreg (g/m², indicating a weight percentage of the carbon fiber and the resin in the carbon fiber prepreg), the resin layers and the carbon fiber layers are both of multi-layer in a manner that each resin layer is impregnated with two adjacent carbon fiber layers so that the carbon fiber layers are able to be consolidated firmly for strengthening overall structure of the carbon fiber prepreg.

### BACKGROUND OF THE INVENTION

### 1. Field of the Invention

The present invention relates to a carbon fiber prepreg, particularly to a carbon fiber prepreg exclusive of any additive scrims, e.g., glass fibers, carbon fabrics, cotton fabrics, other kinds of fabrics, or combinations thereof, and including multiple layers respectively stacked on each other in an integral form at each standard unit of the carbon fiber prepreg represented by g/m², indicating a weight percentage of the carbon fiber and the resin in the carbon fiber prepreg.

### 2. Related Art

As well known, carbon fiber having physical properties including high tensile strength and tensile modulus and also having steady performance in its chemical properties, such as corrosion resistance, chemical resistance, high and low temperature tolerance, etc. has become a preferred resource for making high performance composite material such as a carbon fiber prepreg. To produce the carbon fiber prepreg, a carbon fiber roving is supplied at the beginning for being processed with impregnation, consolidation, etc. On the purpose of producing a more shapeable and strong structural composite material during manufacturing, the carbon fiber roving is necessary to be processed with planar distribution by a spreader, then with impregnation for being impregnated with resin, and with consolidation of the carbon fiber roving that has been impregnated with resin carried out by two adjacent rollers each further coated with resin on its surface for enhancing fiber impregnation of the prepreg and squeezing out any excess voids, and eventually processed with cooling or drying, so the shapeable and strong structural carbon fiber prepreg could be obtained in an integrally formed manner. Such prepreg is measured by a standard specification, represented by g/m² as a standard unit indicating a weight percentage of the carbon fiber and the resin in the carbon fiber prepreg. An example of a reel of the carbon fiber prepreg 5 used to provide for the manufacturer is shown in FIG. 1. For viewing convenience, a partially enlarged view of FIG. 1 is provided as FIG. 2. As shown in FIG. 2, the conventional carbon fiber prepreg 5 for each standard unit (g/m²) is composed of a carbon fiber layer 51, a resin layer 52 impregnated on outer surfaces of the carbon fiber layer 51, and most top and bottom coating layers 53,54. In applications, the conventional carbon fiber prepreg 5 is tailored in a required size for combining with a working product during shaping process. In the combination with the working product, one of the coating layers 53(54) of the conventional carbon fiber prepreg 5 is torn off to produce viscosity for pasting on a model of the product, and the other coating layer 54(53) is then torn off in the end of the shaping process.

However, although the carbon fiber itself is excellent in physical and chemical properties for manufacturing processes, there are still some issues in the structural strength of the conventional carbon fiber prepreg 5. That is, one restriction to development thereof is the processing of the carbon fiber roving of which the planar distribution is just not enough for enabling the resin layer 52 to be impregnated inside the carbon fiber layer 51, whereas the resin layer 52 stays on outer surfaces of the carbon fiber layer 51 (FIG. 2), which is outside of the carbon fiber layer 51. Consequently, the overall structure of the conventional carbon fiber prepreg 5 may become unstable on influence of external force and is impossible for further interior structural reinforcement, which may render the strength consideration and shaping process more complex during manufacturing. Especially for nowadays, product requirements for lightening and thinning have been an irreversible tendency. Nevertheless, the possibility of further development on thinning of the conventional carbon fiber prepreg 5 is quite difficult due to limitations on the existing structure. Conventionally, in order to enhance the structural strength of the carbon fiber prepreg 5, other materials such as metals, scrims, e.g., the scrims including glass fabrics, carbon fabrics, cotton fabrics or other fabrics must be added thereto from outside, often causing an increasing thickness of the overall structure. Therefore, it is difficult to meet the product requirements for lightening and thinning on this point. Further, those added materials, especially for metal plates) may lead to an undesirable combination, for which the joint surfaces therebetween are subject to the surrounding temperature and become unstable due to the difference of thermal expansion coefficient. For example, when the surrounding temperature is changing, the joint surfaces may reduce the gripping force and become separable from each other, which may greatly affect the quality of the final product as well. Therefore, it is needed to make a breakthrough on creating a stronger and thinner carbon fiber prepreg.

Based on the inventor's seasoned experiences in the past and multi-assessment, an innovation carbon fiber prepreg is provided to effectively settle the problems mentioned above. The innovation carbon fiber prepreg has been stressed on reinforce of the structure at the same specification (g/m²), thereby prolonging use life and fitting for more applications.

### SUMMARY OF THE INVENTION

An object of the present invention is to provide a carbon fiber prepreg exclusive of any additive scrims, which improves structural strength of the conventional carbon fiber prepreg in the same standard unit (g/m²), that is, the single carbon fiber layer of the conventional carbon fiber prepreg is now replaced with multiple carbon fiber layers, and multiple resin layers are employed to be respectively impregnated between each two of adjacent carbon fiber layers, so that the multiple carbon fiber layers are able to be consolidated firmly for strengthening overall structure of the carbon fiber prepreg.

To attain this, the carbon fiber prepreg, exclusive of any additive scrims, comprises a multiple carbon fiber layers and resin layers in an integrally formed manner, characterized in that: for the carbon fiber prepreg at a standard unit of the carbon fiber prepreg (g/m², indicating a weight percentage of the carbon fiber and the resin in the carbon fiber prepreg), the resin layers and the carbon fiber layers are both of multi-layer in a manner that each resin layer is impregnated with adjacent carbon fiber layers so that the carbon fiber layers are able to be consolidated firmly for strengthening overall structure of the carbon fiber prepreg.

In accordance with the present invention, fiber grains respectively on each carbon fiber layer have different orientations, so that the carbon fiber prepreg provides multi-directional tensile strength and tensile module for strengthening the overall structure.

In accordance with the present invention, the carbon fiber prepreg further comprises at least one strengthening material respectively disposed in at least one of the carbon fiber layers for strengthening the overall structure, wherein the strengthening material is made from metals, metal composite materials, glass fibers, carbon fabrics, cotton fabrics, other kinds of fabrics, or combinations thereof.

### BRIEF DESCRIPTION OF THE DRAWINGS

FIG. 1 is a perspective view showing a reel of a conventional carbon fiber prepreg;

FIG. 2 is a partially enlarged view of FIG. 1;

FIG. 3 is a perspective view showing a reel of a carbon fiber prepreg in accordance with the present invention;

FIG. 4 is a partially enlarged view of FIG. 3;

FIG. 5 is a perspective view of a first embodiment of the present invention;

FIG. 6 is a perspective view of a second embodiment of the present invention; and

FIG. 7 is a perspective view of a third embodiment of the present invention.

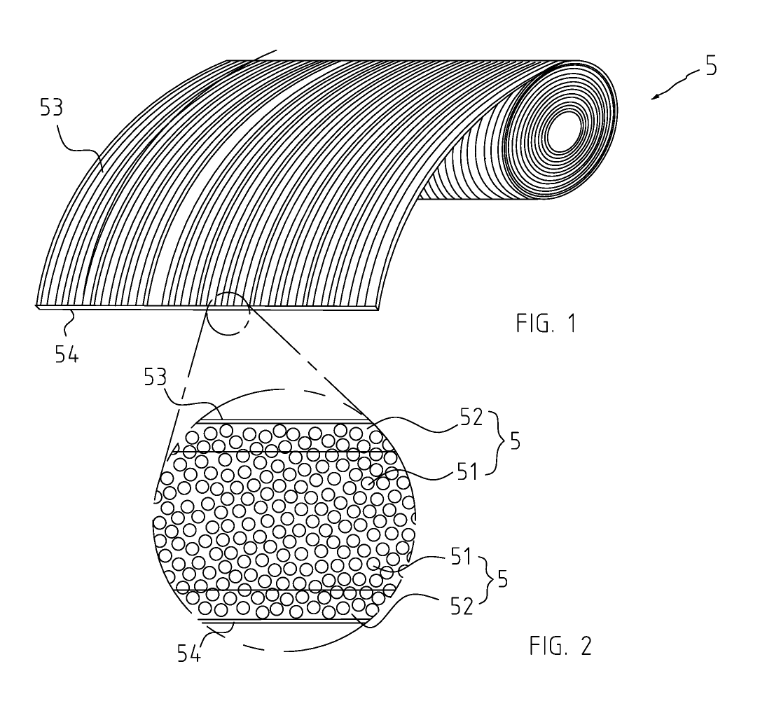

### DETAILED DESCRIPTION OF THE INVENTION

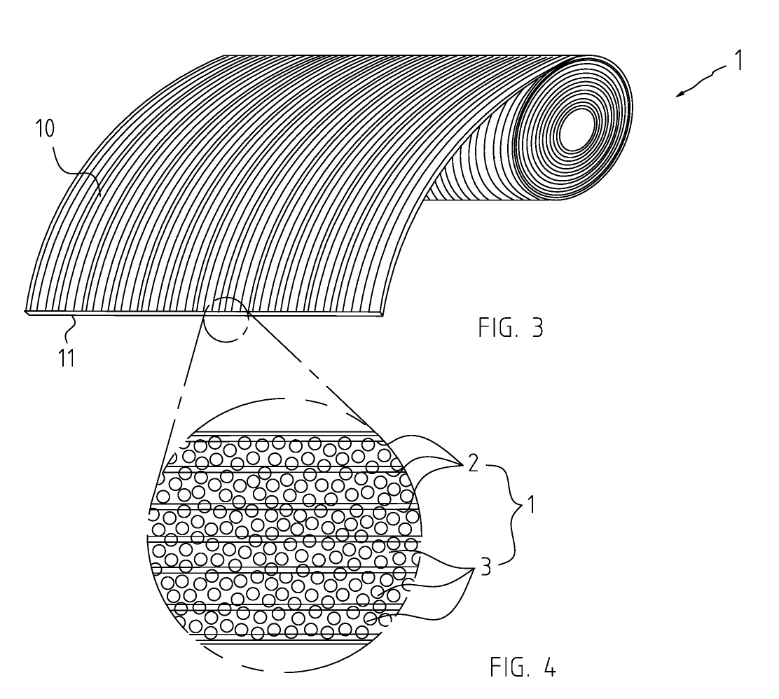

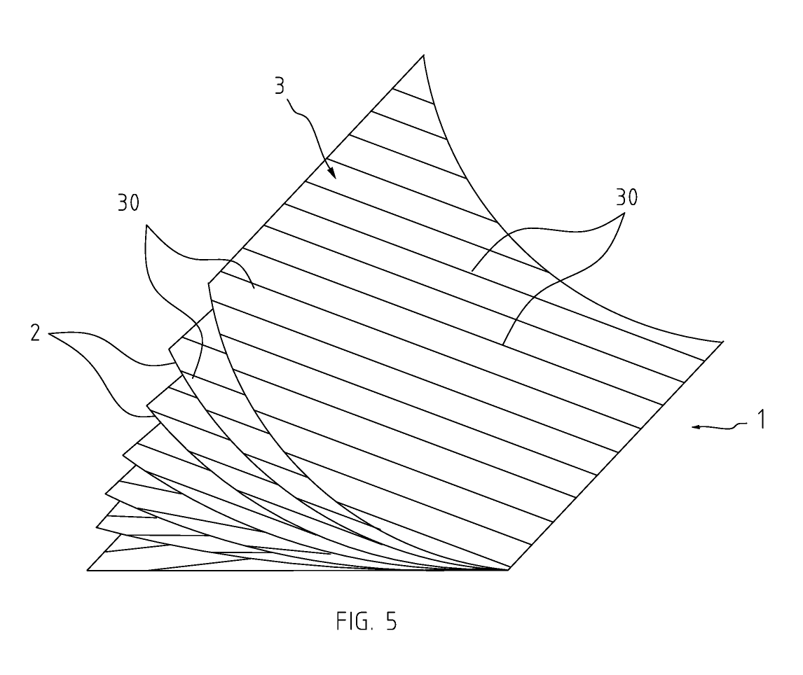

Referring to FIG. 3, which shows a reel of a carbon fiber prepreg 1, the carbon fiber prepreg 1 is prepared by processing a carbon fiber roving with planar distribution by a spreader such as yarn extension machine, then with impregnation for being impregnated with resin, and then with consolidation of the carbon fiber roving impregnated with resin. The resin may be thermosetting resin, thermoplastic resin or thermoplastic plastic. The carbon fiber prepreg 1 is measured by a standard specification, represented by g/m² as a standard unit indicating a weight percentage of the carbon fiber and the resin in the carbon fiber prepreg 1. With reference to FIG. 4 as a partially enlarged view of FIG. 3, the carbon fiber prepreg 1 includes a resin layer 2 and a carbon fiber layer 3. For each standard unit (g/m²) of the carbon fiber prepreg 1 in accordance with the present invention, there are seven resin layers 2 and six carbon fiber layers 3 alternatively stacked on each other, whereas the conventional carbon fiber prepreg 5 for each standard unit (g/m²) only has one carbon fiber layer 51 and two resin layers 52 (FIG. 2) alternatively stacked on each other. As shown in FIG. 3, each single resin layer 2 is impregnated with two carbon fiber layers 3 that are adjacent to the resin layer 2, so that the multiple carbon fiber layers 3 are able to be consolidated firmly for strengthening overall structure of the carbon fiber prepreg 1.

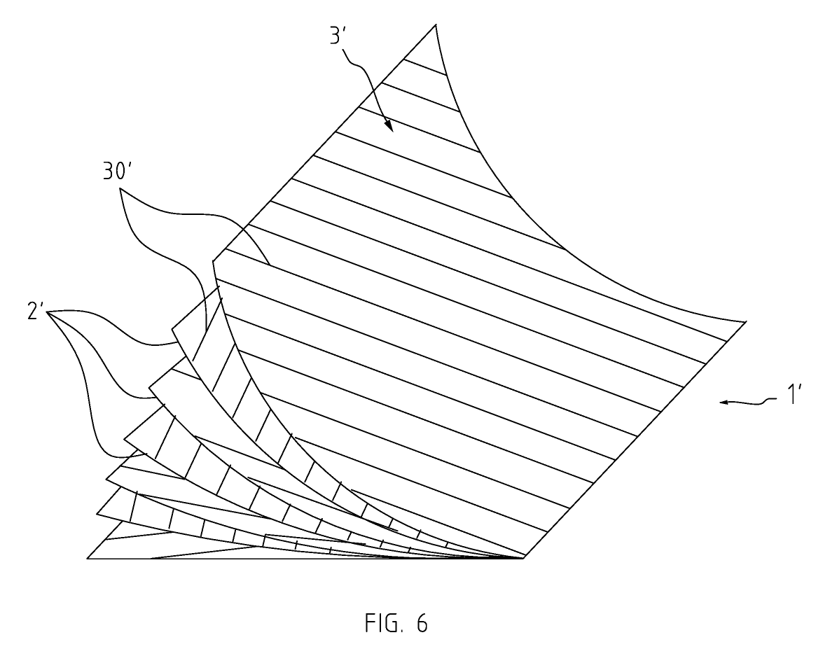

With reference to FIG. 5, which shows a first embodiment in accordance with the present invention, multiple carbon fiber layers 3 of the carbon fiber prepreg 1 have fiber grains 30 thereon oriented in a same direction, that is, the fiber grains 30 respectively on the carbon fiber layers 3 are parallel to each other. Each of the resin layers 2 made of thermosetting resin, thermoplastic resin, or thermoplastic plastic is impregnated and laminated between two adjacent carbon fiber layers 3. Compared with the conventional carbon fiber prepreg 5 for each standard unit (g/m²) only having one carbon fiber layer 51 and two resin layers 52, the carbon fiber prepreg 1 in accordance with the present invention provides multiple carbon fiber layers 3 and resin layers 2 in an integral form for each standard unit (g/m²), so that the multiple carbon fiber layers 3 are able to be consolidated much more firmly so as to strengthen the overall structure of the carbon fiber prepreg 1.

With reference to FIG. 6, which shows a second embodiment in accordance with the present invention, the carbon fiber prepreg 1′ similarly includes a resin layer 2′ and a carbon fiber layer 3′. In comparison with the first embodiment, the difference is that fiber grains 30′ of the carbon fiber layers 3′ of the carbon fiber prepreg 1′ in this embodiment are oriented in different directions from layer to layer, that is, the fiber grains 30′ respectively on the carbon fiber layers 3′ are nonparallel and oriented in different directions to create an inclined angle therebetween ranged from 0° to ±180°. Besides, each of the resin layers 2′ is impregnated and laminated between two adjacent carbon fiber layers 3′. Therefore, the carbon fiber prepreg 1′ in this embodiment provides multiple carbon fiber layers 3′ and resin layers 2′ in an integral form for each standard unit (g/m²). Because the fiber grains 30′ respectively on each carbon fiber layer 3′ have different orientations, the carbon fiber prepreg 1′ provides better tolerance against external axial force and enhances multi-directional tensile strength and tensile module for strengthening the overall structure while compared with the conventional carbon fiber prepreg 5 only having one carbon fiber layer 51 with one direction of grain orientation. Also, performance on the structural strength for the carbon fiber prepreg 1′ in this embodiment is more preferable than that in the first embodiment of the present invention.

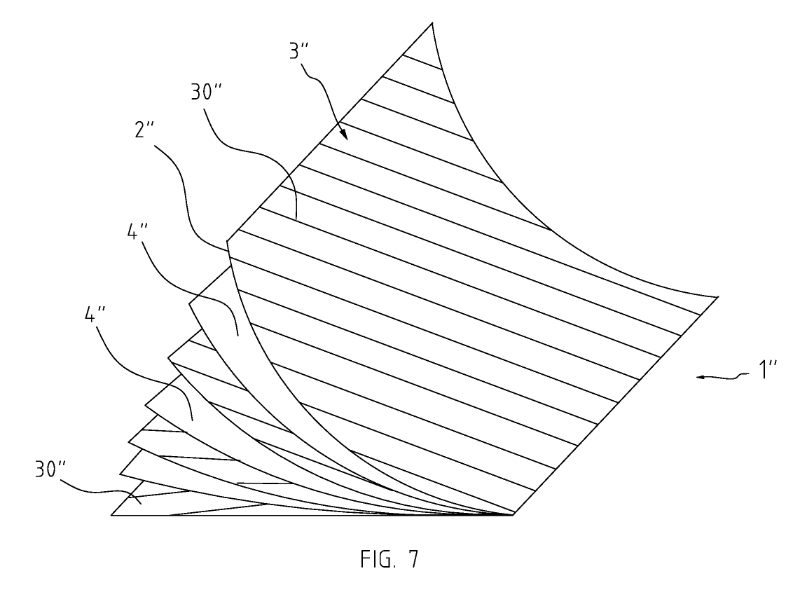

With reference to FIG. 7, which shows a third embodiment in accordance with the present invention, the carbon fiber prepreg 1″ similarly includes a resin layer 2″ and a carbon fiber layer 3″. In comparison with the first embodiment, the difference is that the carbon fiber prepreg 1″ in this embodiment further comprises at least one strengthening material 4″. The strengthening material 4″ can be made from metals, metal composite materials, glass fibers, carbon fabrics, cotton fabrics, other kinds of fabricsm, or combinations thereof. For example, the strengthening material 4″ is a thin aluminum plate in this embodiment and there are three of the strengthening materials 4″ in use. The strengthening materials 4″ are respectively inserted in each of the carbon fiber layers 3″. Each of the strengthening materials 4″ either contains a malleable direction or a grain orientation which is different from fiber grains 30″ of the adjacent carbon fiber layers 3″. Therefore, the carbon fiber prepreg 1″ provides better tolerance against not only axial but also radial external forces and thus enhances multi-directional tensile strength and tensile module for strengthening the overall structure. Alternatively, the strengthening materials 4″ can also be applied on the second embodiment of the present invention in the same way described above for improving performance of the structural strength of prepreg.

In sum, the carbon fiber prepreg in accordance with the present invention, especially for the carbon fiber prepreg exclusive of any additive scrims, e.g., glass fibers, carbon fabrics, cotton fabrics, other kinds of fabrics, or combinations thereof at each standard unit (g/m²) has the following characteristics:

First, compared with the conventional carbon fiber prepreg having only one carbon fiber layer at a standard unit (g/m²), the carbon fiber prepreg in accordance with the present invention is defined with multiple carbon fiber layers, along with multiple resin layers in an integral form for each the standard unit (g/m²), capable of being consolidated much more firmly in the same standard unit (g/m²) so as to strengthen the overall structure of the carbon fiber prepreg.

Second, the fiber grains respectively on each carbon fiber layer in accordance with the present invention are anisotropic and have different orientations, so that the carbon fiber prepreg having the multiple carbon fiber layers provides multi-directional tensile strength and tensile module for strengthening the overall structure.

Third, the carbon fiber prepreg in accordance with the present invention is disposed with at least one strengthening material which is inserted in each of the carbon fiber layers, whereas the conventional carbon fiber prepreg is not able to allow the strengthening material to be inserted in the carbon fiber layer thereof due to limitations on structure. Therefore, the carbon fiber prepreg in accordance with the present invention provides better tolerance against radial and axial external forces and thus enhances multi-directional tensile strength and tensile module so as to greatly strengthen the overall structure.

Fourth, the carbon fiber prepreg in accordance with the present invention at each standard unit (g/m²) is of multi-layer, and a plurality of thin strengthening materials are respectively inserted in each of the carbon fiber layers for strengthening the overall structure. In particular, the thin strengthening materials, thin metal or thin metal composite for example, would barely cause an unstable combination with the carbon fiber prepreg affected by difference of thermal expansion coefficient because each of the strengthening materials is so thin that the joint surfaces between the strengthening materials and the carbon fiber layers would not reduce the gripping force or become separable from each other. Accordingly, the carbon fiber prepreg in accordance with the present invention provides better tolerance against external radial and axial forces as well as properties like fatigue resistance and damage resistance to provide a preferable adaptability in working procedure such as hole drilling, riveted jointing, etc. (producing external axial force), so as to greatly enhance the quality of final product. In contrast, if applied on the conventional carbon fiber prepreg, the strengthening materials (metal plates) must be attached from outside of the conventional carbon fiber prepreg, rather than inside the conventional carbon fiber prepreg. Besides, there are no multiple carbon fiber layers inside the conventional carbon fiber prepreg for the strengthening materials to insert. For achieving the same tolerance against external forces, a number of metal plates must be combined together to form one or two thicker metal plates being added at outside of the conventional carbon fiber prepreg. As a result, the thicker strengthening material(s) are subject to the difference of thermal expansion coefficient, so their joint surfaces with carbon fiber layers may cause the reduction in the gripping force and become separable, which may greatly affect the quality of final product.

It is understood that the invention may be embodied in other forms within the scope of the claims. Thus the present examples and embodiments are to be considered in all respects as illustrative, and not restrictive, of the invention defined by the claims.

What is claimed is:

1. A carbon fiber prepreg, exclusive of any additive scrims, the carbon fiber prepreg comprising a multiple carbon fiber layers and resin layers in an integral form, characterized in that: the carbon fiber prepreg at each standard unit (g/m², indicating a weight percentage of the carbon fiber and the resin in the carbon fiber prepreg) comprises at least two resin layers and at least two carbon fiber layers in a manner that each resin layer is impregnated with two adjacent carbon fiber layers so that the carbon fiber layers are consolidated firmly for strengthening overall structure of the carbon fiber prepreg.

2. The carbon fiber prepreg of claim 1, wherein the resin layers and the carbon fiber layers are alternatively stacked on each other in an integral form.

3. The carbon fiber prepreg of claim 1, wherein fiber grains respectively on each carbon fiber layer have different orientations, so that the carbon fiber prepreg provides multi-directional tensile strength and tensile module.

4. The carbon fiber prepreg of claim 2, wherein fiber grains respectively on each carbon fiber layer have different orientations, so that the carbon fiber prepreg provides multi-directional tensile strength and tensile module.

5. The carbon fiber prepreg of claim 4, further comprising at least one strengthening material at each the standard unit (g/m²) respectively inserted in at least one of the carbon fiber layers.

6. The carbon fiber prepreg of claim 5, wherein the strengthening material either contains a malleable direction or a grain orientation which is different from grain orientations of adjacent carbon fiber layers.

7. The carbon fiber prepreg of claim 5, wherein when a plurality of strengthening materials are employed, the plurality of strengthening materials are respectively inserted in each of the carbon fiber layers in a manner that the plurality of strengthening materials and the carbon fiber layers are alternatively stacked on each other.

8. The carbon fiber prepreg of claim 5, wherein the strengthening material is made from metals, metal composite materials, glass fibers, carbon fabrics, cotton fabrics, other kinds of fabrics, or combinations thereof.

9. A carbon fiber prepreg, exclusive of any additive scrims, the carbon fiber prepreg comprising carbon fiber layers, resin layers and at least one strengthening material in an integral form, characterized in that: for the carbon fiber prepreg at each standard unit (g/m², indicating a weight percentage of the carbon fiber and the resin in the carbon fiber prepreg), the resin layers and the carbon fiber layers are both of multi-layer in a manner that each resin layer is impregnated with two adjacent carbon fiber layers so that the carbon fiber layers are consolidated firmly for strengthening overall structure of the carbon fiber prepreg.

10. The carbon fiber prepreg of claim 9, wherein fiber grains respectively on adjacent carbon fiber layers have different orientations, and the strengthening material either contains a malleable direction or a grain orientation which is different from grain orientations of adjacent carbon fiber layers, so that the carbon fiber prepreg provides multi-directional tensile strength and tensile module for strengthening the overall structure

11. The carbon fiber prepreg of claim 9, wherein the strengthening material is made from metals, metal composite materials, glass fibers, carbon fabrics, cotton fabrics, other kinds of fabrics, or combinations thereof.
